(19) United States
(12) Patent Application Publication
(10) Pub. No.: US 2026/0118695 A1
(43) Pub. Date: Apr. 30, 2026

(54) EYEWEAR AND CONNECTION MEMBER

(71) Applicant: JINS HOLDINGS Inc., Maebashi-shi (JP)

(72) Inventors: Yasunori KITAGAITO, Maebashi-shi (JP); Tatsunori ODA, Maebashi-shi (JP)

(73) Assignee: JINS HOLDINGS Inc., Maebashi-shi (JP)

(21) Appl. No.: 19/358,095

(22) Filed: Oct. 14, 2025

(30) Foreign Application Priority Data
Oct. 24, 2024 (JP) 2024-187337

(51) Int. Cl. G02C 5/22

(52) U.S. Cl. CPC G02C 5/22

(57) ABSTRACT

The eyewear includes a connection member composed of a first and a second connection portion. The first portion is attached to one of the temple or end piece, and the second portion is attached to the other. These portions are joined by corresponding hook portions. An elastic member allows at least one portion to be movable relative to the engagement point of the hooks. The first connection portion includes a first end portion with a protruding arcuate portion. The second connection portion has a second end portion with a corresponding recess. During a bending motion of the connection member, the arcuate portion is inserted into the recess.

### CROSS-REFERENCE TO RELATED APPLICATIONS

This application is based upon and claims the benefit of priority from Japanese Patent Application No. P2024-187337, filed on Oct. 24, 2024, the entire contents of which are incorporated herein by reference.

### TECHNICAL FIELD

The present disclosure relates to eyewear and a connection member.

### BACKGROUND

U.S. Pat. No. 8,757,796 discloses a frame that includes a front frame, an end piece, and a temple. The temple is attached to the end piece via a hinge. The hinge is a so-called spring hinge, which includes a spring configured to retain the temple and allows the temple to open beyond a right angle. U.S. Pat. No. 8,757,796 discloses both a structure in which the hinge rotates about a single axis and a structure in which the hinge has two axes. In the structure in which the hinge has two axes, the hinge rotates about two mutually orthogonal axes.

Japanese Unexamined Patent Publication No. 2006-509173 discloses a hinge system for an eyeglass frame. The hinge system includes a pivot point between a first rigid element and a second rigid element. The end portions of the respective rigid elements have mating bearing surfaces. The hinge system is a so-called spring hinge provided with an elastic means to maintain contact between the bearings. The hinge system includes two pivoting parts, each having a concave region with a curved surface. The two pivoting parts are fitted together through the coupling of the concave regions and are able to pivot relative to each other like links in a chain.

### SUMMARY

In the eyewear provided with a hinge as described above, it is possible to bend the temple in various directions relative to the front frame using the hinge. However, in U.S. Pat. No. 8,757,796, in the case where the temple is bent in various directions relative to the front frame, the front member (the front side element 8) and the base member (the base 15) that form the hinge bend while making line or point contact with their respective contact surfaces, and similarly in Japanese Unexamined Patent Publication No. 2006-509173, the first and second rigid elements bend while maintaining line contact, so that, for example, in the case where the temple is bent in the upward-downward direction, it may wobble in the leftward-rightward direction, leading to instability in the bending operation of the temple relative to the front frame.

The present disclosure is intended to provide eyewear and a connection member that enable stable bending operation of the temple relative to the front frame, even with the use of a spring hinge.

(1) An eyewear according to the present disclosure includes a frame having a front frame provided with an end piece and having a temple, and further includes a connection member connecting the end piece and the temple to each other. The connection member includes a first connection portion connected to one of the temple and the end piece and includes a second connection portion connected to the other of the temple and the end piece. The first connection portion includes a first mounting portion attached to one of the temple and the end piece and includes a first hook portion exposed from the first mounting portion. The second connection portion includes a second mounting portion attached to the other of the temple and the end piece and a second hook portion exposed from the second mounting portion and engaged with the first hook portion. At least one of the first mounting portion and the second mounting portion is configured to be movable, by an elastic member, relative to a hook-engaged portion between the first hook portion and the second hook portion. The first mounting portion includes a first end portion that is in contact with the second mounting portion. The second mounting portion includes a second end portion that is in contact with the first end portion. The first end portion includes an arcuate portion protruding toward the second end portion. The second end portion includes a recess into which the arcuate portion is inserted when the first connection portion is bent toward the second connection portion.

In the eyewear described above, the connection member includes the first connection portion having the first mounting portion and the first hook portion attached to one of the temple and the end piece, and the second connection portion having the second mounting portion and the second hook portion attached to the other of the temple and the end piece. At least one of the first mounting portion and the second mounting portion is configured to be movable, by an elastic member, relative to a hook-engaged portion between the first hook portion and the second hook portion. The first end portion of the first connection portion includes an arcuate portion. The second end portion of the second connection portion includes a recess into which the arcuate portion fits. The first and second connection portions are coupled together by engagement of the first hook portion and the second hook portion. The arcuate portion of the first end portion fits into the recess of the second end portion when the first connection portion is bent toward the second connection portion. The bending of the first connection portion connected to one of the temple and the end piece toward the second connection portion connected to the other of the temple and the end piece allows the arcuate portion to fit into the recess, enabling the bending operation of the temple relative to the end piece of the front frame to be performed in a stable manner.

(2) In the configuration described in item (1), one of the first end portion and the second end portion can have a protrusion. The other of the first end portion and the second end portion can have a hole portion into which the protrusion fits. The protrusion and the hole portion can be in a non-fixed state with respect to each other. In this case, the protrusion formed on one of the first end portion and the second end portion fits into the hole portion formed on the other of the first end portion and the second end portion. The fitting of the protrusion into the hole portion enables stable bending operation of the temple relative to the front end piece of the front frame upon bending of the connection member.

(3) In the configuration described in item (1), the second end portion can include a protrusion. The first end portion can include a hole portion. In this case, when the first connection portion is bent toward the second connection portion, the protrusion formed on the second end portion is capable of being fitted into the hole portion formed on the first end portion. This configuration enables more reliable stability during bending.

(4) In any of the configurations described in items (1) to (3), the first end portion can be cylindrical with an arcuate portion. In this case, the cylindrical configuration of the first end portion simplifies the shape of the first end portion while also enhancing the aesthetic design of the eyewear by intuitively conveying the ability of the temple to bend and rotate freely through 360 degrees relative to the end piece of the front frame.

(5) In any of the configurations described in items (1) to (4), the second connection portion is connected to the end piece, and the second connection portion can be covered by the end piece and the first end portion. In this case, the recess of the second connection portion is capable of being covered by the end piece and also by the first end portion. This configuration makes the recess less visually noticeable from the outside of the eyewear.

(6) A connection member according to the present disclosure is a connection component configured to connect the end piece and the temple of the eyewear to each other, and includes a first connection portion connected to one of the temple and the end piece and a second connection portion connected to the other of the temple and the end piece. The first connection portion includes a first mounting portion attached to one of the temple and the end piece and includes a first hook portion exposed from the first mounting portion. The second connection portion includes a second mounting portion attached to the other of the temple and the end piece and a second hook portion exposed from the second mounting portion and engaged with the first hook portion. At least one of the first mounting portion and the second mounting portion is configured to be movable, by an elastic member, relative to a portion where the first hook portion is engaged with the second hook portion. The first mounting portion includes a first end portion that is in contact with the second mounting portion. The second mounting portion includes a second end portion that is in contact with the first end portion. The first end portion includes an arcuate portion protruding toward the second end portion. The second end portion includes a recess into which the arcuate portion is inserted when the first connection portion is bent toward the second connection portion. Similar to the eyewear described above, the connection member also includes the second end portion with a recess. The recess is configured to allow insertion of the arcuate portion of the first end portion upon bending of the first connection portion toward the second connection portion. Accordingly, similar effects to those of the eyewear described above can be achieved with the connection member.

According to the present disclosure, stable bending operation of the temple relative to the front frame is enabled.

### BRIEF DESCRIPTION OF THE DRAWINGS

FIG. 1 is a perspective view illustrating eyewear and a connection member according to an embodiment;

FIG. 2 is an enlarged perspective view illustrating the connection member of the eyewear;

FIG. 3 is a perspective view illustrating a first connection portion and a second connection portion of the connection member of FIG. 2;

FIG. 4A is a perspective view illustrating the first connection portion connected to a temple and the second connection portion connected to an end piece;

FIG. 4B is a perspective view illustrating the connection member in a bent state of the temple;

FIG. 5 is an exploded perspective view illustrating the connection member;

FIG. 6 is an enlarged perspective view illustrating the connection member in a bent state; and

FIG. 7 is an enlarged perspective view illustrating the connection member being bent in a direction different from the direction illustrated in FIG. 6.

### DETAILED DESCRIPTION

An embodiment of eyewear and a connection member according to the present disclosure is now described with reference to the drawings. In the description of the drawings, identical or corresponding elements or components are denoted by the same reference numerals, and redundant descriptions are omitted as appropriate. The drawings are partially simplified or exaggerated for clarity in some cases, and the dimensional proportions are not limited to those illustrated in the drawings.

The term “eyewear” as used herein refers to a device worn to cover the eyes of a user. The term “eyewear” as used herein includes eyeglasses that correct refractive errors of the eye such as myopia, hyperopia, or astigmatism, sunglasses for decorative purposes around the eyes, and goggles for eye protection. Additionally, the term “temple” as used herein refers to a pair of rod-shaped portions of the eyewear that face the temples and ears of the user when the eyewear is worn. The temple is also called a sidepiece or an arm.

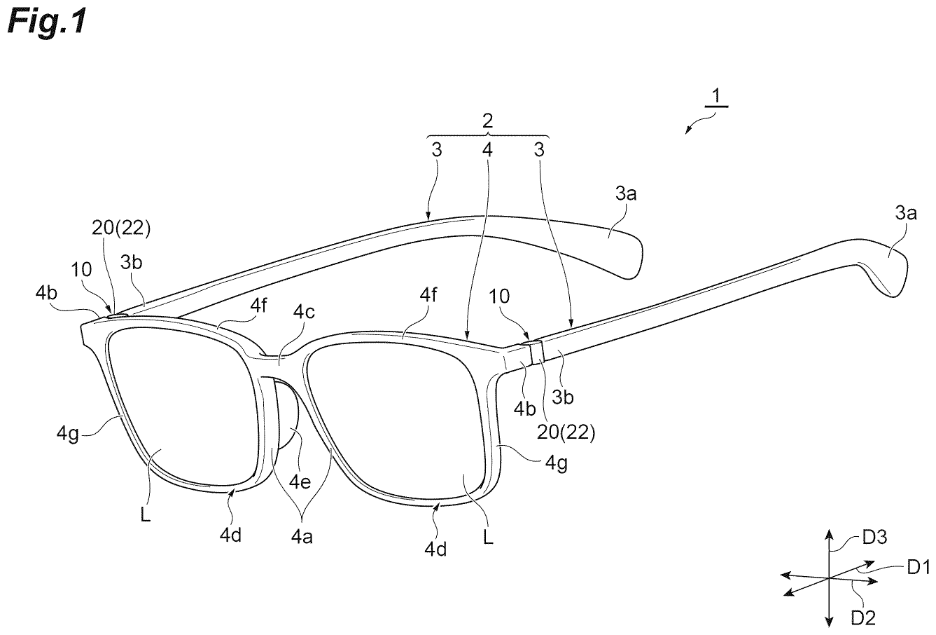

FIG. 1 is a perspective view illustrating eyewear 1 and a connection member 10 according to the present embodiment. The eyewear 1 includes a frame 2, a lens L, and a connection member 10. The frame 2 includes a temple 3 and a front frame 4. The frame 2 includes a pair of the temples 3. The temple 3 is, for example, rod-shaped. The frame 2 is made of, for example, a resin material.

In the following description, the extending direction of the temple 3 is defined as a first direction D1, the direction in which the pair of temples 3 are aligned is defined as a second direction D2, and the direction orthogonal to both the first and second directions D1 and D2 is defined as a third direction D3. Note that these directions are defined for the convenience of description and are not intended to limit the arrangement position or orientation of the components. Additionally, in some cases, from the perspective of a user wearing the eyewear 1, the front side can be referred to as “front”, “forward”, or “forward side”, the rear side as “rear”, “rearward”, or “back side”, the upper side as “upper”, “upward”, or “upper portion”, and the lower side as “lower”, “downward”, or “lower region”.

For example, the temple 3 includes a rear end portion 3a. The rear end portion 3a is located on the opposite side of the temple 3 from the front frame 4. For example, the rear end portion 3a has a width in the third direction D3 that is greater than the width in the third direction D3 of the part of the temple 3 other than the rear end portion 3a. The pair of rear end portions 3a can be curved in directions facing each other.

The front frame 4 extends in the second direction D2. The front frame 4 connects front end portions 3b of the pair of temples 3 to each other. The front frame 4 includes an end piece 4b, a bridge 4c, a rim 4d, and a pad 4e.

The front frame 4 includes a pair of the rims 4d. The rims 4d are located on either side of the front frame 4 in the second direction D2. The pair of rims 4d are aligned in the second direction D2. The rim 4d is annular in shape. For example, the rim 4d has a length in the second direction D2 that is longer than the length of the rim 4d in the third direction D3. The rim 4d includes a first edge 4a, a second edge 4f, and a third edge 4g.

The bridge 4c is interposed between the pair of rims 4d. The bridge 4c is located at the central part of the front frame 4 in the second direction D2. The bridge 4c is located on one side (upper side) in the third direction D3. The bridge 4c is connected to the first edge 4a of the rim 4d. The first edge 4a extends downward from the bridge 4c and reaches the central area of the rim 4d in the second direction D2. The first edge 4a is located on the side of the rim 4d closer to the bridge 4c in the second direction D2. The pair of first edges 4a are aligned in the second direction D2.

The second edge 4f extends from the end piece 4b to the bridge 4c. The second edge 4f is located on one side in the third direction D3 (upper side) of the rim 4d. The second edge 4f extends in the second direction D2. The pair of second edges 4f are aligned in the second direction D2. The second edge 4f has one end connected to the bridge 4c. The second edge 4f has the other end connected to the end piece 4b.

The third edge 4g extends downward from the end piece 4b and reaches the central area of the rim 4d in the second direction D2. The third edge 4g is located on the opposite side of the rim 4d from the bridge 4c (i.e., lower side). The third edge 4g extends in the third direction D3. The pair of third edges 4g are aligned in the second direction D2. The third edge 4g has one end portion in the third direction D3 connected to the end piece 4b.

The end piece 4b, which has a substantially L-shaped configuration in a plan view, extends from the second edge 4f and the third edge 4g toward the temple 3. The end piece 4b has a portion connected to the temple 3, and this portion can be, for example, rectangular parallelepiped. Specifically, for example, the length of the end piece 4b in the first direction D1 is greater than the length of the end piece 4b in the second direction D2 and the length of the end piece 4b in the third direction D3. The front frame 4 includes a pair of the end pieces 4b. The pair of end pieces 4b are aligned in the second direction D2.

The pad 4e is a nose pad that comes into contact with the user's nose. The material of the pad 4e is, for example, silicone resin. The pad 4e is formed on the first edge 4a of the rim 4d. The pad 4e protrudes rearward from the rim 4d. The front frame 4 includes a pair of the pads 4e. The pair of pads 4e are placed against the user's nose to sandwich the nose from both sides in the second direction D2. The shape, size, material, and other factors of the pads 4e are modifiable as appropriate.

The lens L is fitted into the rim 4d. The eyewear 1 includes a pair of the lenses L. The pair of lenses L are aligned in the second direction D2. The lens L is, for example, a plastic lens, but can also be a glass lens. The lens L can be configured in a spherical shape or in a non-spherical shape such as a planar shape.

The lens L can be a lens for correcting visual acuity, a contrast lens, or a polarizing lens. The lenses L can also be a lens that lacks a photochromic function or polarizing function, or can be non-vision-correcting lens. Thus, various types of lenses can be employed as the lens L.

The connection member 10 is a component that connects the end piece 4b and the temple 3 to each other. The connection member 10 is interposed between the front frame 4 (end piece 4b) and the temple 3 (front end portion 3b). The eyewear 1 includes a pair of the connection members 10. The pair of connection members 10 are aligned in the second direction D2. The material of the connection member 10 is, for example, metal.

The connection member 10 rotatably connects the temple 3 to the front frame 4. The connection member 10 allows the temple 3 to move upward, downward, leftward, and rightward relative to the front frame 4. The connection member 10 enables opening and closing of the frame 2. As used herein, “closing the frame” refers to bending the pair of temples 3 toward each other to bring them closer relative to the front frame 4, whereas “opening the frame” refers to bending the pair of temples 3 away from each other. The expression “opening and closing the frame” collectively refers to both the operation of “opening the frame” and the operation of “closing the frame”.

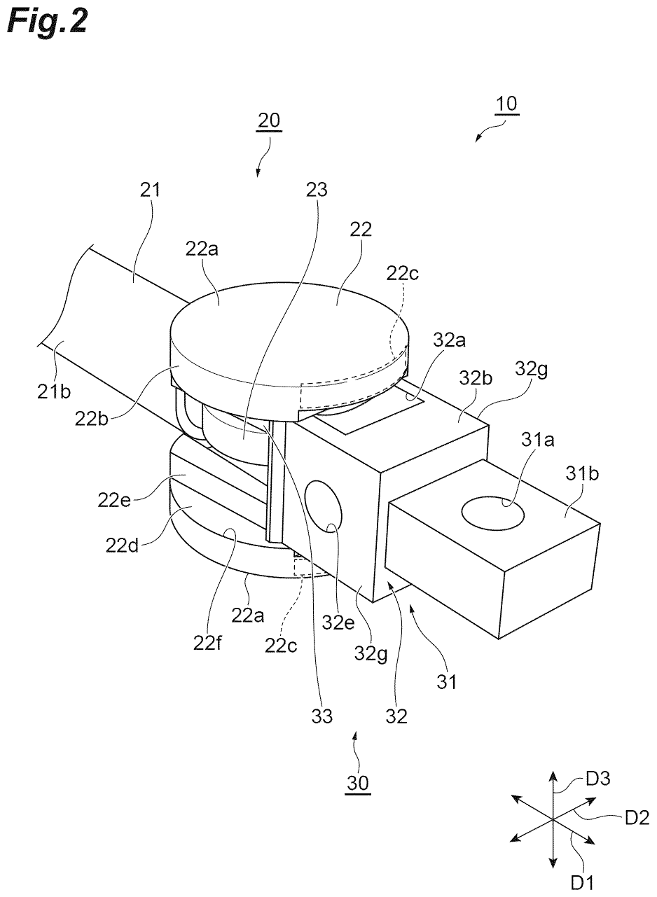

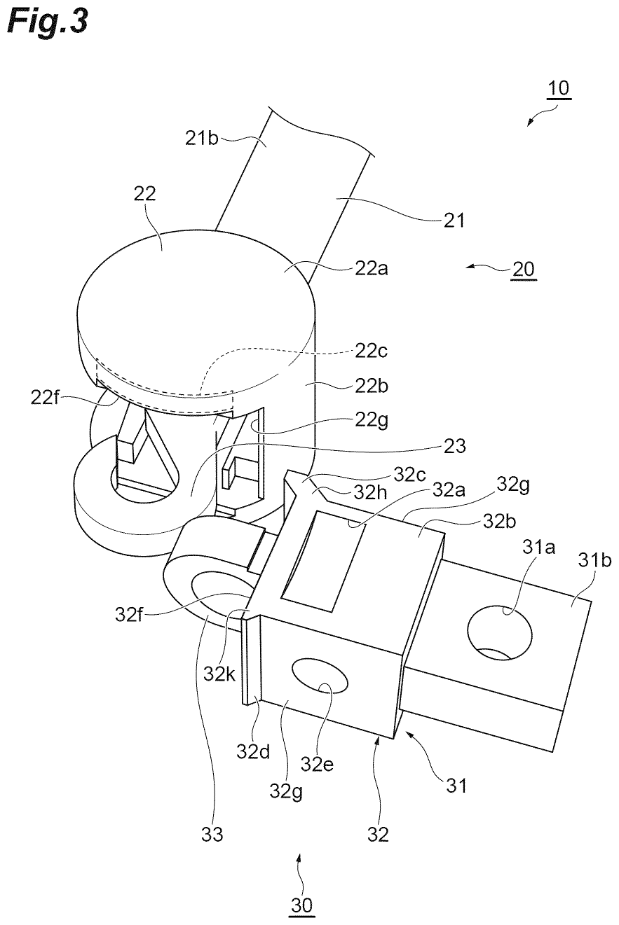

FIG. 2 is an enlarged perspective view illustrating the connection member 10 of the eyewear 1. FIG. 3 is a perspective view illustrating a first connection portion 20 and a second connection portion 30 of the connection member 10 in FIG. 2. As illustrated in FIGS. 1, 2, and 3, the connection member 10 includes the first connection portion 20 and the second connection portion 30. In the assembled state of the eyewear 1, the first connection portion 20 and the second connection portion 30 are aligned in the first direction D1.

In the assembled state of the eyewear 1, the first connection portion 20 (a first end portion 22 described later) of the connection member 10 is easily visible in appearance under the condition that the eyewear 1 is worn, while most of the parts of the connection member 10 other than the first end portion 22 are concealed by the resin that constitutes the temple 3 and the end piece 4b. This configuration reduces the exposure of the mechanical parts of the connection member 10, enabling the enhancement of the aesthetic design of the eyewear 1 as a simple appearance in which metal parts connect between the temple 3 and the end piece 4b.

The first connection portion 20 is connected to the temple 3. The temple 3 has a cavity inside. The first connection portion 20 has a part, namely a first mounting portion 21 (described later), which fits into the cavity of the temple 3. Specifically, the first connection portion 20 is connected to the temple 3, with the part thereof being inserted into the cavity of the temple 3.

The first connection portion 20 includes a first mounting portion 21 and a first hook portion 23. The first mounting portion 21 includes a first end portion 22. The first mounting portion 21 is a portion configured to attach the first connection portion 20 to the temple 3. The first connection portion 20 is attached to the temple 3 by the first mounting portion 21 being inserted into the cavity of the temple 3. The first mounting portion 21 is, for example, tubular (in one embodiment, cylindrical). The first mounting portion 21 extends, for example, in the first direction D1.

The first mounting portion 21 includes, for example, a tubular portion 21b. The first end portion 22 is connected to one end of the tubular portion 21b in the first direction D1. The first end portion 22 is, for example, columnar. As described above, in the assembled state of the eyewear 1, the first end portion 22, formed in a columnar shape, of the connection member 10 is easily visible in appearance. This configuration makes it possible to enhance the aesthetic design of the eyewear 1.

For example, the width in the second direction D2 of the cross section of the first end portion 22, which is orthogonal to the first direction D1, is greater than the width in the second direction D2 of the cross section of the first mounting portion 21, which is also orthogonal to the first direction D1. For example, the first end portion 22 has a first surface 22a and a second surface 22b. The first surface 22a corresponds to the top and bottom surfaces of the first end portion 22 formed in a columnar shape, and the second surface 22b corresponds to the lateral surface of the first end portion 22 formed in a columnar shape.

The first surface 22a is, for example, a surface facing the third direction D3. The first surface 22a is, for example, perfectly circular when viewed from the third direction D3. Note that the shape of the first surface 22a is not limited to a perfect circle, and can be, for example, an oval or other shape. The first end portion 22 has a pair of the first surfaces 22a aligned in the third direction D3, and, between the pair of first surfaces 22a, the second surface 22b extends in the third direction D3. The second surface 22b is, for example, a surface facing a direction perpendicular to the third direction D3. At least a part of the second surface 22b is configured as an arcuate surface. The tubular portion 21b has one end connected to the second surface 22b.

The first end portion 22 includes an arcuate portion 22c. The arcuate portion 22c is a part of the first end portion 22. The arcuate portion 22c is, for example, the part of the first end portion 22 opposite to the tubular portion 21b. The arcuate portion 22c includes, for example, a region where the first surface 22a intersects with the second surface 22b. The arcuate portion 22c includes a region where the first surface 22a and the second surface 22b are connected to each other.

The first end portion 22 includes an opening 22f. From the opening 22f, the first hook portion 23 protrudes. The opening 22f faces opposite to the tubular portion 21b. The opening 22f is formed in the second surface 22b. In one example, the first end portion 22 has a pair of first portions 22d, which are disk-shaped portions located above and below the opening 22f, respectively, and also has a second portion 22e located between the pair of first portions 22d. The first portion 22d includes a first surface 22a and a second surface 22b. The second portion 22e protrudes from an inner surface of the first portion 22d opposite to the first surface 22a. The second portion 22e is, for example, rod-shaped.

The first end portion 22 includes a hole portion 22g. The hole portion 22g is formed in the second surface 22b of the first end portion 22. In one example, the length of the hole portion 22g in the circumferential direction of the first end portion 22 is shorter than the length of the hole portion 22g in the third direction D3. The expression “circumferential direction of the first end portion 22” as used herein refers to a direction along a ring centered on an imaginary axis, which passes through the center of the first end portion 22 formed in a columnar shape and extends in the third direction D3.

The hole portion 22g is, for example, located at one end of the opening 22f in the outer circumferential direction of the first end portion 22. For example, the hole portion 22g is continuous from the opening 22f. In this case, the hole portion 22g is located at one end of the opening 22f in the outer circumferential direction. However, the hole portion 22g can also be formed separately from the opening 22f.

The first hook portion 23 is exposed from the first mounting portion 21. The first hook portion 23 is exposed from the first end portion 22. The first hook portion 23 is exposed from the opening 22f in the first direction D1. For example, the first hook portion 23 is fixed inside the first mounting portion 21 and extends in the first direction D1 inside the first mounting portion 21. The first hook portion 23 is, for example, hook-shaped. In one example, when viewed from the third direction D3, the first hook portion 23 is J-shaped. The first hook portion 23 can also be J-shaped when viewed from the first direction D1, and the orientation of the first hook portion 23 is not limited to any particular direction. The first hook portion 23 will be described in detail later.

The second connection portion 30 is connected to the end piece 4b. The end piece 4b has a cavity inside. The second connection portion 30 is, for example, inserted into the cavity of the end piece 4b. In this way, the second connection portion 30 is connected to the end piece 4b, and a part of the second connection portion 30 is covered by the end piece 4b.

The second connection portion 30 includes a second mounting portion 31 and a second hook portion 33. The second mounting portion 31 includes a second end portion 32. The second mounting portion 31 is attached to the end piece 4b. The second mounting portion 31 is formed, for example, in a rectangular parallelepiped shape. Note that the second mounting portion 31 can also be tubular (in one embodiment, square tubular), and the shape of the second mounting portion 31 is not limited to any particular shape.

The second mounting portion 31 includes, for example, a first through-hole 31a. The first through-hole 31a penetrates the second mounting portion 31 in the third direction D3. To fix the second connection portion 30 inserted into the cavity of the end piece 4b to the end piece 4b, a screw (not illustrated) is inserted into the first through-hole 31a. The insertion of the screw into the end piece 4b and the first through-hole 31a allows the second connection portion 30 to be fixed to the end piece 4b.

The second mounting portion 31 has, for example, a box-shaped portion 31b. The second end portion 32 is, for example, adjacent to the second end portion 32 in the first direction D1. In other words, the second end portion 32 is aligned with the box-shaped portion 31b in the first direction D1. The second end portion 32 is formed, for example, in a rectangular parallelepiped shape. However, the second end portion 32 can be tubular (in one embodiment, rectangular tubular), and the shape of the second end portion 32 is not limited to any particular shape. For example, the length of the second end portion 32 in the second direction D2 is greater than the length of the box-shaped portion 31b in the second direction D2. For example, the length of the second end portion 32 in the third direction D3 is greater than the length of the box-shaped portion 31b in the third direction D3.

The second end portion 32 includes, for example, a first side surface 32b, a second side surface 32f intersecting the first side surface 32b, and a third side surface 32g intersecting both the first side surface 32b and the second side surface 32f. The second end portion 32 includes a recess 32a. The recess 32a is formed as a depression in the first side surface 32b. The arcuate portion 22c of the first end portion 22 of the first connection portion 20 is inserted into the recess 32a upon bending of the temple 3.

The first side surface 32b is, for example, a surface of the second end portion 32 facing the third direction D3 (upward). The recess 32a is, for example, located closer to the side of the second end portion 32 opposite to the box-shaped portion 31b with respect to the center of the second end portion 32. The second end portion 32 can include, for example, a plurality of recesses 32a (e.g., two in one example). In this case, the recesses 32a are formed on each of the first side surfaces 32b facing both sides in the third direction D3. In other words, the recesses 32a are formed on both the upper and lower sides of the second end portion 32.

The recess 32a is, for example, rectangular in shape when viewed from the third direction D3. The length of the recess 32a in the second direction D2 is greater than the length of the recess 32a in the first direction D1. The depth of the recess 32a can be constant or can vary. For example, the depth of the recess 32a can increase toward the central area of the recess 32a in the second direction D2. For example, a cross section of the recess 32a when cut along a plane extending in the second direction D2 and the third direction D3 has an arcuate shape.

In this case, the radius of curvature of the arcuate portion of the cross section of the recess 32a can be greater than the radius of curvature of the arcuate portion 22c described above. For example, the thickness of the arcuate portion 22c is smaller than the width of the recess 32a in the first direction D1.

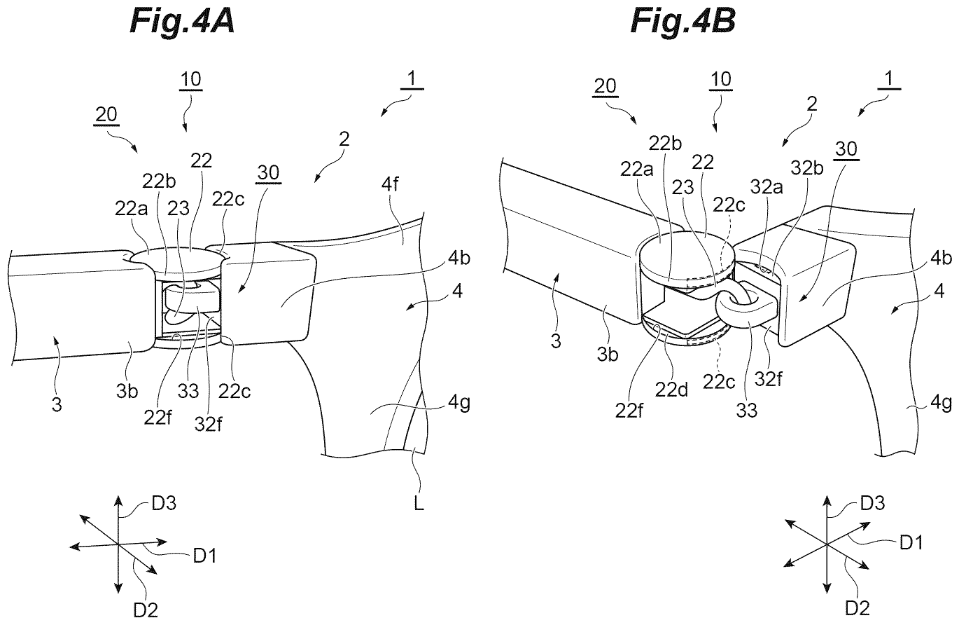

FIG. 4A is an enlarged perspective view illustrating the first connection portion 20 connected to the temple 3 and the second connection portion 30 connected to the end piece 4b, as viewed from the wearer's side (inner side) in the case where the eyewear 1 is worn. As illustrated in FIG. 4A, in a state where the temple 3 and the end piece 4b are aligned in a straight line, the recess 32a and the first side surface 32b (see FIG. 2) are covered in the third direction D3 (upward-downward direction) by the arcuate portion 22c of the first end portion 22 of the first connection portion 20 and by the end piece 4b, making the recess 32a and the first side surface 32b less visually recognizable in appearance. The part of the end piece 4b that faces the arcuate portion 22c can also be formed in an arcuate shape along the arcuate portion 22c.

FIG. 4B is a perspective view illustrating the connection member 10 in a state where the temple 3 is further bent in the opening direction, i.e., the second direction D2 from the state illustrated in FIG. 4A. As illustrated in FIG. 4B, when the temple 3 is further bent in the opening direction, a part of the recess 32a and a part of the first side surface 32b become exposed from the first end portion 22, while the remaining part of the first side surface 32b remains covered by the end piece 4b. The manner in which the temple 3 is bent will be described in detail later.

The second connection portion 30 is covered by the end piece 4b and the first end portion 22. More specifically, the box-shaped portion 31b (see FIG. 3) and the third side surface 32g of the second connection portion 30 are covered by the end piece 4b. The first side surface 32b and the recess 32a are covered by the end piece 4b and the arcuate portion 22c of the first end portion 22. Upon bending of the temple 3 relative to the end piece 4b in the second direction D2 or the third direction D3, the second side surface 32f and the second hook portion 33 become exposed when viewed from a direction other than the inner side.

As described above, in the assembled state of the eyewear 1, the recess 32a becomes difficult to visually recognize. Since the first end portion 22 formed in a columnar shape of the first connection portion 20 is easily visible in appearance, it is possible to improve the aesthetic design of the eyewear 1, and at the same time, it becomes possible to reduce or prevent foreign substances from entering the recess 32a, which is covered in the upper and lower directions by the arcuate portion 22c of the first end portion 22.

Referring again to FIGS. 2 and 3, the configuration is described below. The second end portion 32 includes a protrusion 32c. The protrusion 32c is located, for example, at the distal end of the second end portion 32 in the first direction D1. The protrusion 32c is formed at a corner portion 32h of the second end portion 32. The corner portion 32h is located at the corner of the first side surface 32b and extends in the third direction D3. The protrusion 32c protrudes obliquely relative to both the first direction D1 and the second direction D2 from the corner portion 32h.

The second end portion 32 includes, for example, a projecting portion 32d. The projecting portion 32d is located, for example, at the distal end of the second end portion 32 in the first direction D1. The projecting portion 32d is formed at a corner portion 32k other than the corner portion 32h at which the protrusion 32c is provided. The projecting portion 32d is, for example, aligned with the protrusion 32c in the second direction D2.

The second hook portion 33 is exposed from the second mounting portion 31. The second hook portion 33 is exposed from the second end portion 32. For example, the second end portion 32 has an internal space that accommodates the second hook portion 33 and an opening that is formed in the second side surface 32f in communication with the internal space, and through the opening, the second hook portion 33 is exposed in the first direction D1. For example, the second hook portion 33 is fixed inside the second end portion 32, and a part of the second hook portion 33 protrudes from the second end portion 32. The second hook portion 33 is, for example, annular when viewed from the second direction D2. The second hook portion 33 can also be annular when viewed from the third direction D3, and the orientation of the second hook portion 33 is not limited to a particular direction.

As described above, the first hook portion 23 is hook-shaped, and the second hook portion 33 is annular. The first hook portion 23 is engaged with the second hook portion 33. Alternatively, the first hook portion 23 can be annular, and the second hook portion 33 can be hook-shaped. The second end portion 32 has, for example, a second through-hole 32e. The second through-hole 32e penetrates the second end portion 32 in the second direction D2. To fix the second hook portion 33 inserted into the internal space of the second end portion 32 to the second end portion 32, a screw (not illustrated) is inserted into the second through-hole 32e. The insertion of the screw into the second through-hole 32e and the second hook portion 33 allows the second hook portion 33 to be fixed to the second end portion 32.

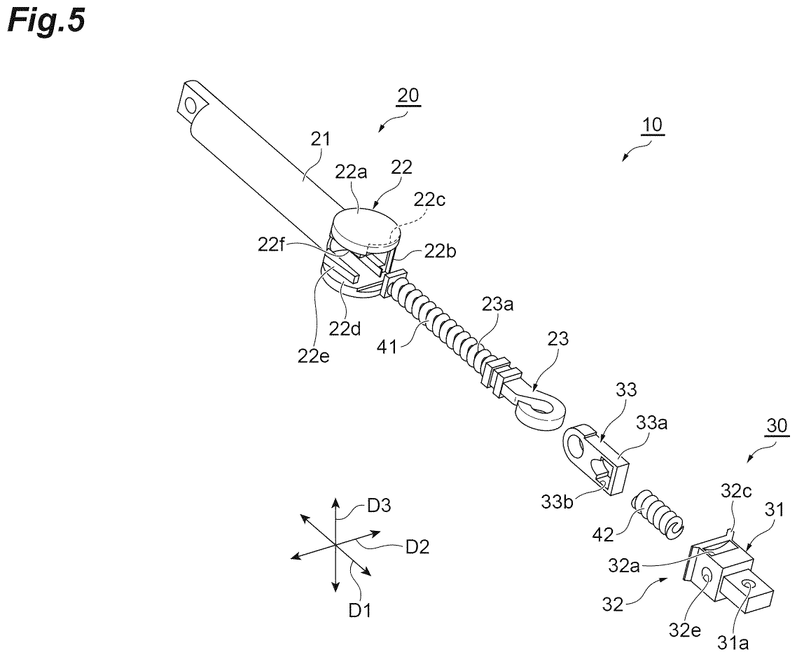

FIG. 5 is an exploded perspective view illustrating the connection member 10. As illustrated in FIGS. 3 and 5, a part of the first hook portion 23 is disposed inside the first mounting portion 21 (the tubular portion 21b). The first hook portion 23 extends, for example, in the first direction D1. The first hook portion 23 has, for example, a portion 23a that is accommodated inside the first mounting portion 21, and the portion 23a is, for example, rod-shaped.

A part of the second hook portion 33 is disposed in the internal space of the second end portion 32. The second hook portion 33 extends, for example, in the first direction D1. The second hook portion 33 includes, for example, a portion 33a that is accommodated inside the second end portion 32, and the portion 33a is, for example, plate-shaped.

The second hook portion 33 has, for example, a hole 33b. The hole 33b penetrates the portion 33a of the second hook portion 33 in the second direction D2. The screw mentioned above (the screw for fixing the second hook portion 33 to the second end portion 32) is inserted into the hole 33b. The insertion of the screw into the second through-hole 32e of the second end portion 32 and the hole 33b allows the second hook portion 33 to be fixed to the second end portion 32.

The connection member 10 includes a first elastic member 41 and a second elastic member 42 (elastic bodies). The first elastic member 41 and the second elastic member 42 are, for example, extendable and retractable in the first direction D1. The first elastic member 41 and the second elastic member 42 are, for example, coil springs (helical springs). The first elastic member 41 and the second elastic member 42 are springs that have elasticity against compressive force. Upon application of an external force, the first elastic member 41 and the second elastic member 42 generate a restoring force that acts in opposition to the external force.

The first elastic member 41 is disposed inside the first connection portion 20. The first elastic member 41 is disposed, for example, around the outer periphery of the portion 23a of the first hook portion 23 that is not exposed from the first end portion 22. The second elastic member 42 is disposed inside the second connection portion 30. The second elastic member 42 is disposed in alignment with the second hook portion 33 in the first direction D1. The length of the first elastic member 41 is longer than the length of the second elastic member 42.

The first elastic member 41 applies a biasing force to the first hook portion 23 inside the first mounting portion 21. The first elastic member 41 has one end fixed to the first mounting portion 21 and has the other end connected to the first hook portion 23. Thus, the first hook portion 23 is configured to be extendable and retractable with respect to the first mounting portion 21. The second elastic member 42 applies a biasing force to the second hook portion 33 inside the second end portion 32. The second elastic member 42 has one end fixed to the second end portion 32 and has the other end connected to the second hook portion 33. Thus, the third hook portion 33 is configured to be extendable and retractable with respect to the second mounting portion 31.

Through the engagement of the first hook portion 23 with the second hook portion 33, the first mounting portion 21 of the first connection portion 20 is connected to the second mounting portion 31 of the second connection portion 30. The second end portion 32 of the second connection portion 30 is connected to the first end portion 22 of the first connection portion 20. As a result, the first connection portion 20 and the second connection portion 30 are mutually coupled.

As illustrated in FIGS. 1 and 5, in the present embodiment, the first mounting portion 21 of the first connection portion 20 is inserted into the temple 3, and the second mounting portion 31 of the second connection portion 30 is inserted into the end piece 4b. The first hook portion 23 is made extendable and retractable relative to the first mounting portion 21 by the first elastic member 41, and the second hook portion 33 is made extendable and retractable relative to the second mounting portion 31 by the second elastic member 42. Thus, by the engagement of the first hook portion 23 with the second hook portion 33, the second connection portion 30 is connected to the first connection portion 20.

Accordingly, the first mounting portion 21 attached to the temple 3 and the second mounting portion 31 attached to the end piece 4b are made movable relative to the portion where the first hook portion 23 is engaged with the second hook portion 33. Thus, the temple 3 is movable relative to the end piece 4b in the upward, downward, leftward, and rightward directions, and is rotatable about an imaginary axis extending in the first direction D1. In other words, the extension direction of the temple 3 can be variably changed with the end piece 4b as a pivot point, and the temple 3 can be freely bent relative to the end piece 4b.

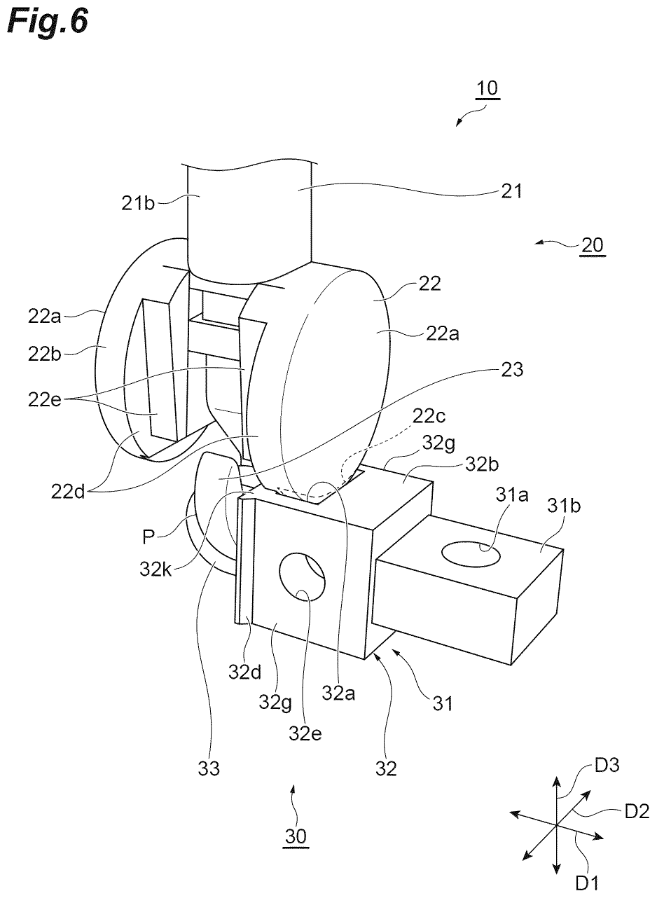

FIG. 6 is an enlarged perspective view illustrating the connection member 10 in a bent state. FIG. 6 illustrates a state in which the first connection portion 20 is bent towards the second connection portion 30. In the example illustrated in FIGS. 1 and 6, the temple 3 is bent to move upward relative to the end piece 4b.

For example, the first connection portion 20 is bent by 90 degrees relative to the second connection portion 30. The first mounting portion 21 and the second mounting portion 31 are made movable, by the first elastic member 41 and the second elastic member 42, relative to a hook-engaged portion P where the first hook portion 23 is engaged with the second hook portion 33. The first connection portion 20 is rotatable relative to the second connection portion 30 about an imaginary straight line that passes through the hook-engaged portion P and extends in the second direction D2. For example, the first connection portion 20 is rotatable approximately 90 degrees from the first direction D1 toward both sides (upward and downward directions) of the third direction D3.

The arcuate portion 22c of the first end portion 22 of the first connection portion 20 protrudes toward the second end portion 32 of the second connection portion 30. The arcuate portion 22c fits into the recess 32a of the second end portion 32 of the second connection portion 30 when the first connection portion 20 is bent toward the second connection portion 30. When the arcuate portion 22c fits into the recess 32a, the arcuate portion 22c moves further inside the second end portion 32, beyond the first side surface 32b of the second end portion 32. In this state, the arcuate portion 22c can be caught by the inner wall of the recess 32a, and in this case, the movement of the arcuate portion 22c in the first direction D1 is restricted.

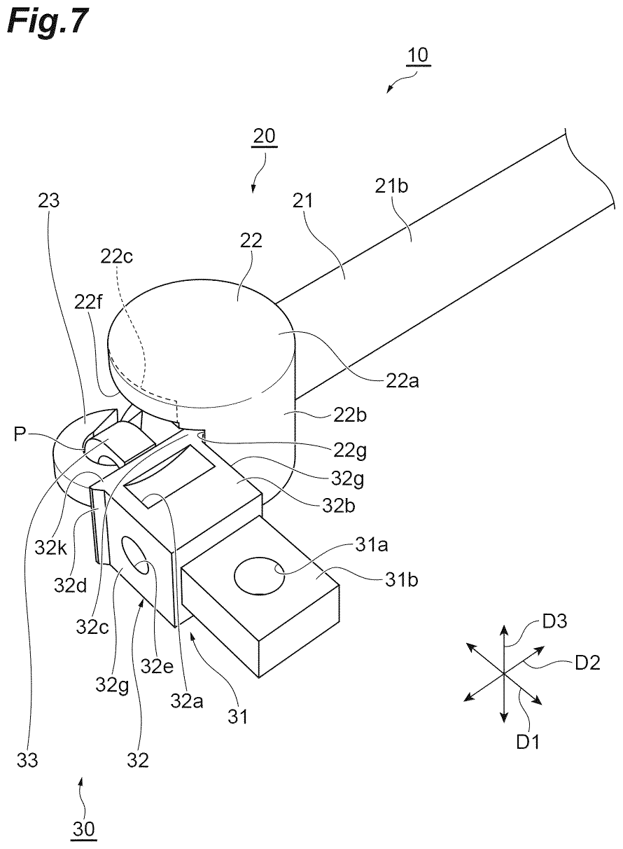

FIG. 7 is an enlarged perspective view illustrating the connection member 10 in a bent state in a direction different from that illustrated in FIG. 6. In the example illustrated in FIGS. 1 and 7, the temple 3 is bent relative to the end piece 4b so as to move from the first direction D1 toward the second direction D2 (opening direction). The first connection portion 20 is rotatable with respect to the second connection portion 30 about an imaginary axis extending through the hook-engaged portion P in the third direction D3 as a central axis.

For example, the first connection portion 20 is configured to be rotatable by approximately 90 degrees to both sides (leftward and rightward) along the second direction D2. The first connection portion 20 is rotatable by approximately 90 degrees in both the opening direction and the closing direction, which is opposite to the opening direction. The state in which the first connection portion 20 is rotated by approximately 90 degrees in the closing direction corresponds to a bent state of the temple 3 during normal use (i.e., a bent state for stowing the eyewear 1). In the case where the temple 3 is bent relative to the end piece 4b so as to move in the second direction D2, the protrusion 32c of the second end portion 32 of the second connection portion 30 fits into the hole portion 22g of the first end portion 22 of the first connection portion 20.

The first connection portion 20 is movable relative to the second connection portion 30 in a direction inclined with respect to both the second direction D2 and the third direction D3. The first connection portion 20 is rotatable by 360 degrees relative to the second connection portion 30 about an imaginary straight line serving as a central axis, the line passing through the hook-engaged portion P and extending in the first direction D1. In other words, the connection member 10 enables the temple 3 to rotate 360 degrees relative to the front frame 4 about an imaginary straight line on which the temple 3 and the front frame 4 are aligned. The connection member 10 also enables the rear end portion 3a of the temple 3 to rotate 360 degrees along a circular path on an imaginary plane parallel to the plane defined by the second direction D2 and the third direction D3.

The functional effects achieved from the eyewear 1 and the connection member 10 according to the present embodiment are now described in more detail. In the eyewear 1, the connection member 10 includes the first connection portion 20 and the second connection portion 30, the first connection portion 20 being provided with the first mounting portion 21, which is attached to the temple 3, and the first hook portion 23, and the second connection portion 30 being provided with the second mounting portion 31, which is attached to the end piece 4b, and the second hook portion 33. The first mounting portion 21 and the second mounting portion 31 are movable, by the first elastic member 41 and the second elastic member 42, relative to the hook-engaged portion P where the first hook portion 23 is engaged with the second hook portion 33. The first end portion 22 of the first connection portion 20 has the arcuate portion 22c. The second end portion 32 of the second connection portion 30 has the recess 32a into which the arcuate portion 22c fits. The first connection portion 20 and the second connection portion 30 are connected to each other through the engagement between the first hook portion 23 and the second hook portion 33.

Upon bending of the first connection portion 20 toward the second connection portion 30, the arcuate portion 22c of the first end portion 22 fits into the recess 32a of the second end portion 32. The bending of the first connection portion 20 connected to the temple 3 toward the second connection portion 30 connected to the end piece 4b allows the arcuate portion 22c to fit into the recess 32a, and thus the first connection portion 20 is bent relative to the second connection portion 30 with the portion where the arcuate portion 22c fits into the recess 32a as a pivot point, thereby suppressing displacement in directions other than the bending direction and enabling a stable bending operation. In the present embodiment, stability is ensured when the temple 3 is bent relative to the end piece 4b about an imaginary axis extending in the second direction D2. Thus, the bending operation of the temple 3 relative to the end piece 4b of the front frame 4 is enabled in a stable manner.

In the present disclosure, the term “arcuate” encompasses not only an arcuate shape but also shapes other than an arcuate shape. The “arcuate portion” can have any shape as long as it achieves similar operational effects as described above, and it is not limited to a strictly arc-shaped configuration. In addition, even if the material of the first connection portion 20 and the second connection portion 30 is metal, the first connection portion 20 does not come into contact with the end piece 4b made of resin because the arcuate portion 22c fits into the recess 32a and is bent, thereby reducing wear of the end piece 4b.

In the present embodiment, the arcuate portion 22c can be configured to come into contact with the recess 32a. As described above, the cross-sectional shape of the recess 32a when cut along a plane extending in the second direction D2 and the third direction D3 is arcuate in shape. Thus, in comparison to the recess 32a having a flat bottom surface, the contact area between the arcuate portion 22c and the recess 32a can be increased. Accordingly, since the arcuate portion 22c can be brought into surface contact with the recess 32a when the temple 3 is bent relative to the end piece 4b, it is possible to stabilize the bending operation.

In the present embodiment, the second end portion 32 has the protrusion 32c, and the first end portion 22 has the hole portion 22g into which the protrusion 32c fits. The protrusion 32c and the hole portion 22g are in a non-fixed state with respect to each other. The fitting of the protrusion 32c into the hole portion 22g allows the first connection portion 20 to bend relative to the second connection portion 30 with the hook-engaged portion serving as a pivot point, thereby suppressing displacement in directions other than the bending direction and enabling a stable bending operation. In the present embodiment, it is possible to ensure stability when the temple 3 is bent relative to the end piece 4b about an imaginary axis extending in the third direction D3. This allows the bending operation of the temple 3 relative to the end piece 4b of the front frame 4 to be performed even more stably.

In the present embodiment, the first end portion 22 has a cylindrical shape that includes the arcuate portion 22c. In this case, the cylindrical configuration of the first end portion 22 simplifies its overall shape and enhances the aesthetic appearance of the eyewear 1 by intuitively conveying the ability of the temple 3 to bend and freely rotate 360 degrees relative to the end piece 4b of the front frame 4.

In the present embodiment, the second connection portion 30 is connected to the end piece 4b. The second connection portion 30 is covered by the end piece 4b and the first end portion 22. This makes the recess 32a less noticeable visually from the exterior of the eyewear 1 and also prevents foreign matter from entering the recess 32a.

The above describes the embodiments of the eyewear and the connection member according to the present disclosure. However, the eyewear and the connection member disclosed herein are not limited to the details of the above-mentioned embodiment, and may be further modified within the scope of the subject matter defined in the claims. In other words, the shapes, sizes, materials, numbers, and arrangements of the respective components of the eyewear and the connection member according to the present disclosure may be appropriately modified within the scope of the disclosed concept.

For example, in the embodiment described above, the first connection portion 20 is connected to the temple 3, and the second connection portion 30 is connected to the end piece 4b. However, the configuration may be such that the first connection portion 20 is connected to the end piece 4b and the second connection portion 30 is connected to the temple 3.

In the embodiment described above, in one example, the eyewear 1 includes the first elastic member 41 accommodated in the first mounting portion 21 and the second elastic member 42 accommodated in the second mounting portion 31. However, the eyewear can be configured to include only either the first elastic member 41 accommodated in the first mounting portion 21 or the second elastic member 42 accommodated in the second mounting portion 31.

In the embodiment described above, the second end portion 32 includes the protrusion 32c and the first end portion 22 includes the hole portion 22g. However, the first end portion 22 can be configured to include a protrusion and the second end portion 32 can be configured to include a hole portion. In the embodiment described above, the first end portion 22 has the cylindrical shape and includes the arcuate portion 22c. However, as long as the first end portion includes an arcuate portion, the overall shape of the first end portion can have a non-cylindrical shape.

In the embodiment described above, the recess 32a faces both sides along the third direction D3. However, the recess 32a can be configured to face a direction other than the third direction D3. For example, the recess 32a can face both sides in the second direction D2.

What is claimed is:

1. An eyewear comprising:
a frame including a front frame and a temple, the front frame being provided with an end piece; and
a connection member connecting the end piece and the temple to each other, wherein
the connection member includes a first connection portion and a second connection portion, the first connection portion being connected to one of the temple and the end piece, and the second connection portion being connected to the other of the temple and the end piece,
the first connection portion includes a first mounting portion and a first hook portion, the first mounting portion being attached to one of the temple and the end piece, and the first hook portion being exposed from the first mounting portion,
the second connection portion includes a second mounting portion and a second hook portion, the second mounting portion being attached to the other of the temple and the end piece, and the second hook portion being exposed from the second mounting portion and being engaged with the first hook portion,
at least one of the first mounting portion and the second mounting portion is configured to be movable, by an elastic member, relative to a hook-engaged portion between the first hook portion and the second hook portion,
the first mounting portion includes a first end portion in contact with the second mounting portion,
the second mounting portion includes a second end portion in contact with the first end portion,
the first end portion includes an arcuate portion protruding toward the second end portion, and
the second end portion includes a recess configured to allow insertion of the arcuate portion upon bending of the first connection portion toward the second connection portion.

2. The eyewear according to claim 1, wherein
one of the first end portion and the second end portion includes a protrusion,
the other of the first end portion and the second end portion includes a hole portion configured to allow insertion of the protrusion, and
the protrusion and the hole portion are in a non-fixed state with respect to each other.

3. The eyewear according to claim 2, wherein
the second end portion includes the protrusion, and
the first end portion includes the hole portion.

4. The eyewear according to claim 1, wherein
the first end portion has a cylindrical shape including the arcuate portion.

5. The eyewear according to claim 1, wherein
the second connection portion is connected to the end piece, and
the second connection portion is covered by the end piece and the first end portion.

6. A connection member
connecting a temple and an end piece of eyewear, the connection member comprising:
a first connection portion configured to be connected to one of the temple and the end piece; and
a second connection portion configured to be connected to the other of the temple and the end piece, wherein
the first connection portion includes a first mounting portion and a first hook portion, the first mounting portion being attached to one of the temple and the end piece, and the first hook portion being exposed from the first mounting portion,
the second connection portion includes a second mounting portion and a second hook portion, the second mounting portion being attached to the other of the temple and the end piece, and the second hook portion being exposed from the second mounting portion and being engaged with the first hook portion,
at least one of the first mounting portion and the second mounting portion is configured to be movable, by an elastic member, relative to a portion where the first hook portion is engaged with the second hook portion,
the first mounting portion includes a first end portion in contact with the second mounting portion,
the second mounting portion includes a second end portion in contact with the first end portion,
the first end portion includes an arcuate portion protruding toward the second end portion, and
the second end portion includes a recess configured to allow insertion of the arcuate portion upon bending of the first connection portion toward the second connection portion.
